(19) United States
(12) Patent Application Publication
(10) Pub. No.: US 2011/0115605 A1
(43) Pub. Date: May 19, 2011

(54) ENERGY HARVESTING SYSTEM

(75) Inventors: Steven J. Dimig, Plymouth, WI (US); Abdel Salah, Greenfield, WI (US)

(73) Assignee: STRATTEC SECURITY CORPORATION, Milwaukee, WI (US)

(21) Appl. No.: 12/948,161

(22) Filed: Nov. 17, 2010

Related U.S. Application Data
(60) Provisional application No. 61/261,883, filed on Nov. 17, 2009.

(51) Int. Cl. G06F 7/04; B60L 1/00

(52) U.S. Cl. 340/5.61; 307/9.1

(57) ABSTRACT

An energy harvesting system for use with a vehicle including an RF transmitter positionable in a vehicle and a key fob having an antenna configured to receive an RF signal from the RF transmitter and convert the RF signal to electrical energy, a power management circuit configured to distribute the electrical energy in the key fob, and an energy storage device configured to store at least some of the electrical energy converted from the RF signal.

### CLAIM OF PRIORITY UNDER 35 U.S.C. §119

This application claims priority under 35 U.S.C. §119 to U.S. Provisional Patent Application 61/261,883 entitled “Energy Harvesting System” filed on Nov. 17, 2009, the disclosure of which is hereby incorporated by reference in its entirety.

### BACKGROUND

The present invention relates to an energy harvesting system. More specifically, the present invention relates to an energy harvesting system for use with a vehicle.

Radio frequency (or RF) power transmission is utilized to transmit power over a distance without using wires. A typical RF power transmission system includes a power source including an RF transmitter that emits a signal consisting of radio waves and a powered device including an antenna that receives the signal and converts the signal into electrical energy.

### SUMMARY

The present invention provides, in one aspect, an energy harvesting system including an RF transmitter positionable in a vehicle and a key fob having an antenna configured to receive an RF signal from the RF transmitter and convert the RF signal to electrical energy, a power management circuit configured to distribute the electrical energy in the key fob, and an energy storage device configured to store at least some of the electrical energy converted from the RF signal.

The present invention provides, in another aspect, an energy-harvesting key fob including an antenna configured to receive an RF signal from an RF transmitter and convert the RF signal to electrical energy, a power management circuit configured to distribute the electrical energy in the key fob, and an energy storage device configured to store at least some of the electrical energy converted from the RF signal.

The present invention provides, in yet another aspect, a method of harvesting energy including transmitting an RF signal from a vehicle, receiving the RF signal with an antenna included in a key fob, converting the RF signal to electrical energy, and storing the electrical energy in an energy storage device included in the key fob.

The invention also provides a vehicle having a key fob, a first antenna coupled to the key fob, and a second antenna coupled to the vehicle. In addition, a power management circuit is coupled to the key fob, the power management circuit being capable of converting a radio frequency signal to electrical energy; and an energy storage device is coupled to the key fob, the energy storage device selectively receiving electrical energy from the power management circuit.

In yet another embodiment the invention provides a vehicle including a key fob, a 3D-antenna coupled to the key fob, and a second antenna coupled to the vehicle for sending a radio frequency signal to the key fob. In addition, a power management circuit is coupled to the key fob, the power management circuit being capable of converting a radio frequency signal to electrical energy; and an energy storage device is coupled to the key fob, the energy storage device selectively receiving electrical energy from the power management circuit.

Other aspects of the invention will become apparent by consideration of the detailed description and accompanying drawings.

### BRIEF DESCRIPTION OF THE DRAWINGS

FIG. 1 illustrates a schematic view of a first embodiment of an energy harvesting system of the present invention.

FIG. 2 illustrates a schematic view of a second embodiment of the energy harvesting system of the present invention.

FIG. 3 illustrates a schematic view of a third embodiment of the energy harvesting system of the present invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

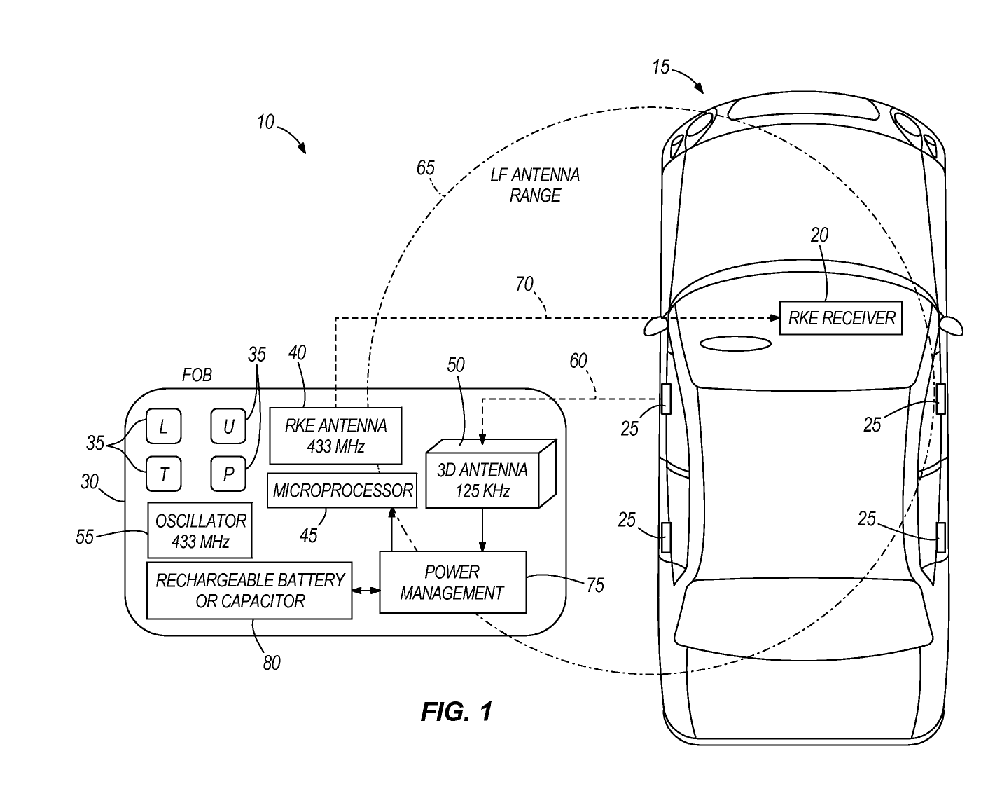

FIG. 1 schematically illustrates a first embodiment of an energy harvesting system 10 including a plurality of low-frequency (LF) antennas 25 (e.g., operating at 125 KHz) incorporated within a vehicle 15 and a key fob 30 operable to harvest energy from the LF antennas 25. In the illustrated embodiment of the system 10, the LF antennas 25 are components of a passive entry and/or passive start system in the vehicle 15 in which neither a key nor the active pressing of a fob button to unlock the vehicle 15 or start the vehicle's engine is required. The vehicle 15 also includes a separate remote keyless entry (RKE) system having an RKE receiver 20 positioned in the vehicle 15.

As shown in FIG. 1, the energy-harvesting key fob 30 includes a plurality of buttons 35, an RKE antenna 40, a microprocessor 45, a 3D LF antenna 50, and an oscillator 55 usually associated with the RKE and passive systems. In operation of the RKE system, the buttons 35 interface with the microprocessor 45 to control a variety of functions including, for example, unlocking and locking the doors or trunk of the vehicle 15, or starting the vehicle's engine. Particularly, in response to one or more of the buttons 35 being depressed, the microprocessor 45 sends an electrical current to the RKE antenna 40 which, in turn, converts the electrical current to radio waves for a one-way transmission to the RKE receiver 20. Particularly, the microprocessor 45 works in conjunction with the oscillator 55 to generate a command signal 70 at a specified frequency (for example, 433 MHz), which is then transmitted by the RKE antenna 40 in the form of radio waves to the RKE receiver 20 in response to one or more of the buttons 35 being depressed. Therefore, an operator of the vehicle 15 may use the RKE system to manually actuate certain components of the vehicle 15 (e.g., the vehicle's doors, trunk, or starter) prior to physically interacting with or touching the vehicle 15.

In operation of the passive entry system, to unlock one of the doors, the driver must trigger the passive entry system by physically interacting with the vehicle 15 (for example, by touching or beginning to open the door handle). This action causes the LF antennas 25 to send a one-way LF signal 60 searching for the energy-harvesting key fob 30 associated with the passive entry system. If the energy-harvesting key fob 30 is within a LF signal area 65, the LF signal 60 is received by the LF antenna 50 which, in turn, converts the LF signal 60 to an electrical current fed to the microprocessor 45. The microprocessor 45 processes the LF signal 60 as an instruction to perform a particular task, and sends a command signal 70 (via the RKE antenna 40) to the RKE receiver 20 to unlock the door. Particularly, the microprocessor 45 works in conjunction with the oscillator 55 to generate the command signal 70 at a specified frequency (for example, 433 MHz), which is then transmitted by the RKE antenna 40 to the RKE receiver 20 in response to the operator's interaction with the vehicle 15.

With continued reference to FIG. 1, the energy-harvesting key fob 30 also includes a power management circuit 75 and an energy storage device 80 (for example, a rechargeable battery or a capacitor). The energy storage device 80 may be configured as a thin-film battery. Thin-film batteries have low leakage rates and a long life (for example, approximately twenty years). Thin-film batteries are especially suitable for constant recharging. Thin-film batteries can be attached to or incorporated with a printed circuit board. For example, a thin-film battery could be attached to or incorporated with the power management circuit 75. Such thin-film batteries are commercially available from Infinite Power Solutions, Inc. of Littleton, Colo. and Cymbet Corporation of Elk River, Minn., among other manufacturers.

In addition to functioning as described above to open the vehicle's doors or trunk, or start the vehicle 15, the passive entry and/or passive start systems (including the LF antennas 25 and the LF antenna 50) may also function in conjunction with the power management circuit 75 and the energy storage device 80 to transmit power to the key fob 30 to charge the energy storage device 80. Particularly, the LF antenna 50 in the key fob 30 receives the LF signal 60 transmitted by the LF antennas 25 and converts the LF signal 60 to an electrical current. The power management circuit 75 receives the current from the LF antenna 50 and controls the distribution of electrical energy to and from the energy storage device 80. The power management circuit 75 also controls the distribution of electrical energy to the microprocessor 45 to operate the various features of the RKE system and the passive entry and/or passive start systems. In one mode of operation, the power management circuit 75 transfers electrical current from the LF antenna 50 to the energy storage device 80 for accumulation and storage. When the energy-harvesting key fob 30 requires electrical energy to perform a function, the energy storage device 80 supplies current to the power management circuit 75 for subsequent distribution to the microprocessor 45. Alternatively, in another mode of operation of the system 10, the power management circuit 75 can distribute harvested current directly from the LF antenna 50 to the microprocessor 45, thereby bypassing the energy storage device 80.

In one mode of operation of the system 10, the LF antennas 25 continuously transmit the LF signal 60 when accessory power is available in the vehicle 15, and the energy-harvesting key fob 30 continuously charges so long as the fob 30 is located inside the LF signal area 65. When the energy storage device 80 is fully charged, the power management circuit 75 directs the microprocessor 45 to deactivate the LF antenna 50 so that the energy-harvesting key fob 30 no longer harvests electrical energy from the LF signal 60. Alternatively, the microprocessor 45 may send a command signal 70 to the RKE receiver 20 to prompt the receiver 20 to deactivate the LF antennas 50 when the energy storage device 80 is fully charged. Consequently, the microprocessor 45 may send another command signal 70 to the RKE receiver 20 to prompt the receiver 20 to re-activate the LF antennas 50 when the energy storage device 80 requires charging. As a further alternative, the LF antenna 50 may remain activated, and the additional energy harvested by the LF antenna 50 (i.e., when the energy storage device 80 is fully charged) may be used directly by the microprocessor 45 or by other power-consuming components in the fob 30 via the power management circuit 75 and microprocessor 45. The recharging intervals of the energy storage device 80 may vary based on the type of energy storage device used, vehicle application, frequency of use of the fob 30, etc.

The energy harvesting system 10 collects energy from an ambient energy source (for example, an existing RF transmitter in a vehicle), converts the ambient energy to electrical energy, and stores the resulting electrical energy for later use. The energy harvesting system 10 can be used to supply all of the electrical energy needed by an electrical device (e.g., the fob 30), or the system 10 can be used to provide an auxiliary or supplemental electrical energy source to the electrical device. The energy harvesting system 10 can eliminate the need to plug in, recharge, or change batteries for small electrical devices (e.g., the fob 30), making those devices self-sufficient for their energy needs.

The energy harvesting system 10 also provides several benefits over a typical RKE system. For example, the energy storage device 80 in energy harvesting system 10 need not be changed, adding convenience and reducing cost for the consumer. Additionally, the energy-harvesting key fob 30 can be permanently sealed, eliminating the battery access door and other components normally associated with holding and accessing a replaceable battery. Sealing the energy-harvesting key fob 30 also reduces the potential for tampering or damage typically associated with replacing a battery in a typical fob. Sealing the energy-harvesting key fob 30 also yields improved water resistance over a typical fob with a replaceable battery. The energy-harvesting key fob 30 may also have a reduced packaging size from typical fobs as a result of using a thin-film battery as the energy storage device 80.

In operation of the energy harvesting system 10, the LF signal 60 supplied by the LF antennas 25 may be the sole source of electrical energy for the energy-harvesting key fob 30 because the fob 30 consumes small amounts of electrical energy when in use compared to the amount of energy that may be accumulated over the duration of time that the fob 30 is exposed to the LF signal 60 for charging. The energy harvesting system 10 collects energy at a relatively slow rate over a relatively long period of time, and stores the collected energy in the energy storage device 80. The fob 30 only requires a small amount of the energy stored by the energy storage device 80 to operate the fob 30 in conjunction with the RKE system or passive systems of the vehicle 15. Because the functions of the energy-harvesting key fob 30 are used only sporadically, and the fob 30 is normally exposed to the LF signal 60 for long periods of time, the energy harvesting system 10 is operable to keep the energy storage device 80 charged during the normal course of use of the fob 30 (for example, when driving the vehicle 15). By charging the energy storage device 80 during the normal course of use of the fob 30, the charging of the energy-harvesting key fob 30 is transparent to the user.

The energy-harvesting system 10 illustrated in FIG. 1 uses a low frequency signal (125 KHz as shown in FIG. 1) between the LF antennas 25 and the LF antenna 50. Other constructions of the energy-harvesting system 10 may use a lower frequency signal between the LF antennas 25 and the LF antenna 50. Low frequencies are useful in an energy-harvesting system 10 when dedicated antennas are available for sending a LF signal to the LF antenna 50. Low frequency signals may experience greater noise, or interference, from other devices as compared to high frequency signals. As such, low frequency signals may require greater power than low frequency signals.

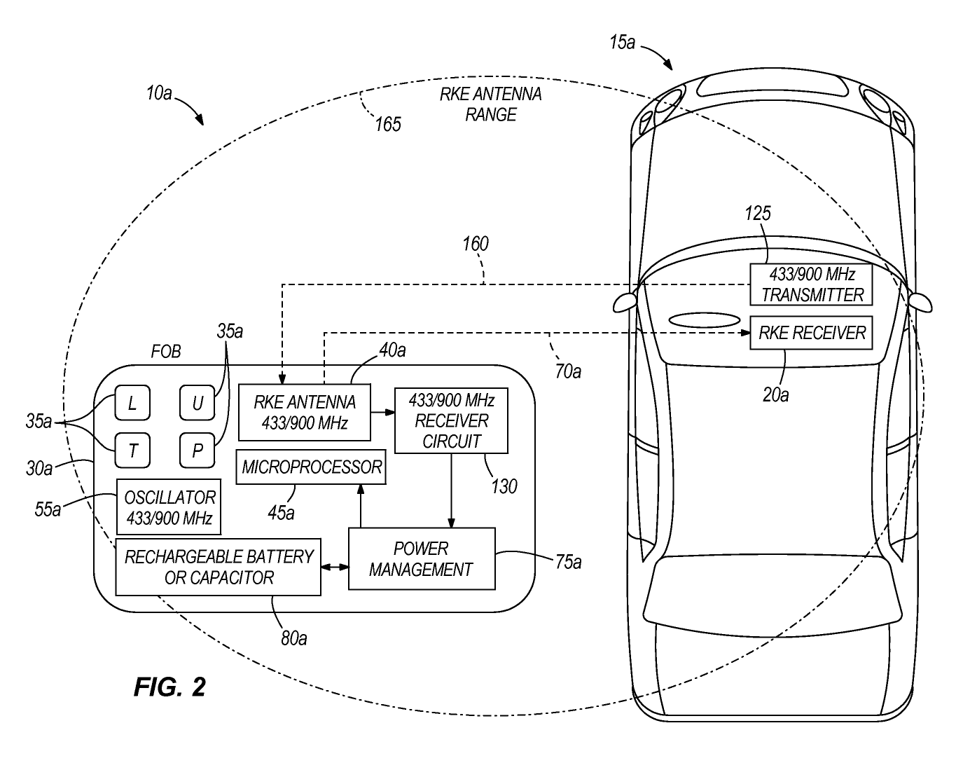

FIG. 2 schematically illustrates a second embodiment of an energy harvesting system 10a including a high frequency transmitter 125 incorporated within a vehicle 15a and a key fob 30a operable to harvest energy from the transmitter 125. The system 10a contains many of the same components as the system 10 shown in FIG. 1 and described above. Therefore, like components are designated with like references numerals plus the letter “a,” and will not be described again in detail.

In the illustrated construction of the system 10a, the transmitter 125 is a component of an RKE system, which also includes a receiver 20a positioned in the vehicle 15a. The transmitter 125 is capable of generating an RF signal 160 (for example, a 433 MHz or 900 MHz signal), which is received by an RKE antenna 40a in the fob 30a. The RKE antenna 40a may also transmit a command signal 70a to the receiver 20a to perform any of the RKE functions or remote start functions discussed above.

The energy-harvesting key fob 30a also includes a power management unit 75a, an energy storage device 80a (for example, a rechargeable battery or a capacitor), and a receiver circuit 130. In operation of the system 10a, the receiver circuit 130 converts the RF signal 160 received by the RKE antenna 40a to an electrical current and distributes the current to the power management circuit 75a. The power management circuit 75a, in turn, distributes the current to the energy storage device 80a or elsewhere within the energy-harvesting key fob 30a. As such, in addition to functioning as described above to open the vehicle's doors or trunk, or start the vehicle 15, the RKE system (including the transmitter 125 and the RKE antenna 40a) may also function in conjunction with the power management circuit 75a and the energy storage device 80a to transmit power to the key fob 30a to charge the energy storage device 80a. The transmitter 125 is capable of providing a signal area 165 larger than the LF signal area 65 provided by the LF antennas 25 in the system 10 shown in FIG. 1. The operation of the system 10a for charging the energy storage device 80a is otherwise identical to that described above with respect to the system 10.

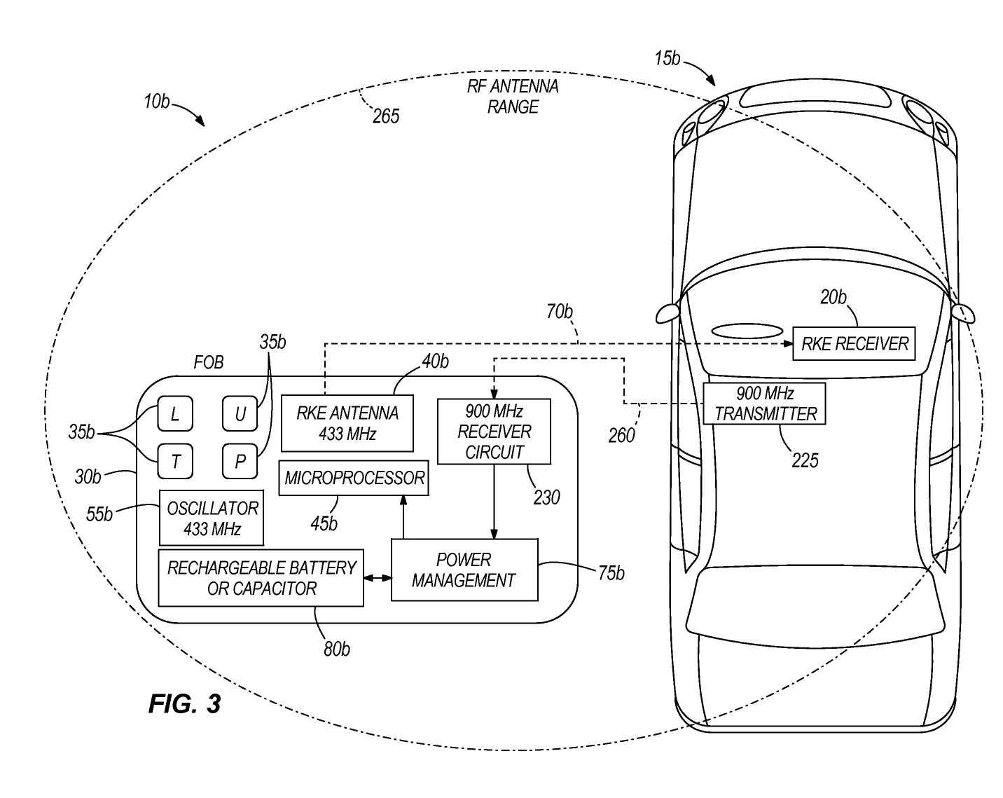

FIG. 3 schematically illustrates a third embodiment of an energy harvesting system 10b including a dedicated, high frequency power transmitter 225 incorporated within a vehicle 15b and a key fob 30b operable to harvest energy from the transmitter 225. The system 10b contains many of the same components as the systems 10, 10a shown in FIGS. 1 and 2 and described above. Therefore, like components are designated with like references numerals plus the letter “b,” and will not be described again in detail.

In the illustrated construction of the system 10b, the transmitter 225 is a separate and distinct component from an RKE system in the vehicle 15b, which otherwise includes a RKE receiver 20b positioned in the vehicle 15b. The power transmitter 225 is capable of generating a high frequency RF signal 260 (for example, a 900 MHz signal).

The energy-harvesting key fob 30b also includes a receiver/antenna 230, a power management circuit 75b, and an energy storage device 80b (for example, a rechargeable battery or capacitor). In operation of the system 10b, the receiver/antenna 230 receives the RF signal 260, converts the RF signal 260 to electrical current, and then distributes the current to the power management circuit 75b. The power management circuit 75b, in turn, distributes the current to the energy storage device 80b or elsewhere within the energy-harvesting key fob 30b. The transmitter 225 is capable of providing a signal area 265 larger than the LF signal area 65 provided by the LF antennas 25 in the system 10 shown in FIG. 1. The operation of the system 10b for charging the energy storage device 80b is otherwise identical to that described above with respect to the system 10.

The energy-harvesting system 10b illustrated in FIG. 3 uses a high frequency signal (900 MHz as shown in FIG. 3) between the transmitter 225 and the receiver 230. Other constructions of the energy-harvesting system 10 may use a higher frequency signal between the transmitter 225 and the receiver 230. A high frequency signal is able to send a greater charge to the energy-harvesting key fob 30b. High frequency signals are useful for sending a signal over greater distances. In addition, high frequency signals may experience minimal interference from other devices.

The energy-harvesting key fob 30, 30a, 30b as described in the embodiments illustrated in FIGS. 1-3, uses only a small amount of energy when interacting with the vehicle 15, thus only a small amount of energy is required to return the energy storage device 80, 80a, 80b to a fully charged state. The small amount of energy can be harvested by the energy-harvesting key fob 30, 30a, 30b even when charging conditions are less than ideal. In wireless charging, a certain percentage of the energy sent between an energy transmitter and an energy receiver is lost. As the distance between the energy transmitter and the energy receiver increases, a greater percentage of the energy sent is lost. Radio wave interference can occur due to other radio waves in the area, or due to objects between the energy transmitter and the energy receiver. As radio wave interference increases, a greater percentage of the energy sent between an energy transmitter and an energy receiver is lost. The energy-harvesting key fob 30, 30a, 30b may be a distance away from the LF antenna 25, 25a, 25b, transmitter 125 or transmitter 225 due to the desire of the consumer to keep the energy-harvesting key fob 30, 30a, 30b in a pocket, purse or bag, however, the energy-harvesting key fob 30, 30a, 30b will still be able to harvest the energy needed to recharge the energy storage device 80, 80a, 80b because only a small amount of energy needs to be harvested. The signals sent from the LF antenna 25, 25a, 25b, transmitter 125 or transmitter 225 may experience radio wave interference due to the presence of other radio waves or objects, however, the energy-harvesting key fob 30, 30a, 30b will still be able to harvest the energy needed to recharge the energy storage device 80, 80a, 80b because only a small amount of energy needs to be harvested.

The energy-harvesting key fob 30, 30a, 30b as described in the embodiments illustrated in FIGS. 1-3, is uniquely appropriate for the situations encountered in the energy-harvesting system 10, 10a, 10b, as described in the embodiments illustrated in FIGS. 1-3, because it only needs to harvest a small amount of energy. For example, the energy-harvesting system illustrated in FIG. 1 is able to harvest sufficient energy for the energy-harvesting key fob from a nominal distance of at least 1 meter, while the energy-harvesting system illustrated in FIGS. 2-3 is able to harvest sufficient energy for the energy-harvesting key fob from a distance of at least 10 meters when interference is minimal.

In an alternative construction of the energy-harvesting system 10, 10a, 10b the energy-harvesting key fob 30, 30a, 30b may be charged at two different rates. This alternative construction may be used with any of the embodiments described herein. A first charging rate is used when the energy storage device 80, 80a, 80b has a charge of above a preset percentage of a maximum charge. A second charging rate is used when the energy storage device 80, 80a, 80b has a charge that is below a preset percentage of the maximum charge. The second charging rate is able to charge the energy storage device 80, 80a, 80b more quickly than the first charging rate. When the second charging rate is being used, then at least one of a more powerful LF signal 60, 60a, 60b is transmitted by the LF antennas 25, 25a, 25b multiple LF signals 60, 60a, 60b are transmitted by the LF antennas 25, 25a, 25b, and the energy harvesting key fob 30, 30a, 30b is configured to receive the second charging rate. It may not be desirable to use the second charging rate when the energy storage device 80, 80a, 80b has a charge of above a preset percentage of a maximum charge because the energy storage device 80, 80a, 80b may have a longer life if it is charged using the first charging rate.

Although the illustrated embodiments have shown a passenger automobile, the energy-harvesting system 10, 10a, 10b can be used in other vehicles as well. For example, the energy-harvesting system 10, 10a, 10b can be used with motorcycles, all-terrain vehicles, boats, buses, trucks, airplanes, electric vehicles, etc.

Thus, the invention provides, among other things, an energy-harvesting system. Various features and advantages of the invention are set forth in the following claims.

1. A vehicle comprising:
a vehicle;
a key fob;
a first antenna coupled to the key fob;
a second antenna coupled to the vehicle;
a power management circuit coupled to the key fob, the power management circuit being capable of converting a radio frequency signal to electrical energy; and
an energy storage device coupled to the key fob, the energy storage device selectively receiving electrical energy from the power management circuit.

2. The vehicle of claim 1, wherein the second antenna is a multi-purpose antenna.

3. The vehicle of claim 1, wherein the power management circuit coupled to the key fob communicates with the vehicle to begin sending a radio frequency signal from the vehicle to the key fob.

4. The vehicle of claim 1, further comprising an oscillator for generating a command signal for transmittal to a vehicle.

5. The vehicle of claim 1, wherein the command signal is a signal which authorizes at least one of a vehicle starting circuit to start, a vehicle trunk to open, and a vehicle door to unlock.

6. The vehicle of claim 1, wherein the first antenna is a 3D low frequency antenna.

7. The vehicle of claim 1, wherein the first antenna is electrically coupled to the power management circuit, and the power management circuit is electrically coupled to the energy storage device.

8. The vehicle of claim 1, wherein the energy storage device is a thin-film battery.

9. The vehicle of claim 1, wherein the power management circuit controls the distribution of electrical energy to and from the energy storage device.

10. The vehicle of claim 1 further comprising a microprocessor, wherein the power management circuit can distribute electrical energy converted from a radio frequency wave directly to the microprocessor.

11. The vehicle of claim 1, wherein the second antenna is a high frequency antenna and the power management circuit is able to convert a radio frequency signal sent by the second antenna to electrical energy for charging the energy storage device when the key fob is at least 10 meters away from the second antenna.

12. The vehicle of claim 1, wherein the second antenna is a low frequency antenna and the power management circuit is able to convert a radio frequency signal sent by the second antenna to electrical energy for charging the energy storage device when the key fob is at least 1 meter away from the second antenna.

13. The vehicle of claim 1 wherein the power management circuit sends a signal to the vehicle to deactivate the second antenna.

14. The vehicle of claim 1 wherein the power management circuit sends a signal to the vehicle to activate the second antenna.

15. A vehicle comprising:
a vehicle;
a key fob;
a 3D-antenna coupled to the key fob;
a second antenna coupled to the vehicle for sending a radio frequency signal to the key fob;
a power management circuit coupled to the key fob, the power management circuit being capable of converting a radio frequency signal to electrical energy; and
an energy storage device coupled to the key fob, the energy storage device selectively receiving electrical energy from the power management circuit.

16. The vehicle of claim 15 further comprising:
a oscillator coupled to the key fob for sending a signal to the vehicle; and
a plurality of antennas coupled to the vehicle for sending and receiving radio frequency signals to and from the key fob.

17. The vehicle of claim 15 further comprising a passive start system for starting the vehicle.

18. The vehicle of claim 15 wherein the power management circuit sends a signal to the vehicle to deactivate the second antenna.

19. The vehicle of claim 15 wherein the power management circuit sends a signal to the vehicle to activate the second antenna.
